(19) United States
(12) Patent Application Publication
(10) Pub. No.: US 2002/0002467 A1
(43) Pub. Date: Jan. 3, 2002

(54) DOOR TO DOORSTEP DIRECTIONS

(76) Inventor: EDWIN KONG SUN HO, MOUNTAIN VIEW, CA (US)

Correspondence Address: KETAN S VAKIL, TOWNSEND AND TOWNSEND AND CREW, TWO EMBARCADERO CENTER, 8TH FLOOR, SAN FRANCISCO, CA, 941113834

(21) Appl. No.: 09/082,311

(22) Filed: May 20, 1998

(51) Int. Cl. G06F 17/60

(52) U.S. Cl. 705/1

(57) ABSTRACT

An apparatus and method for providing general directions and supplementary information over a network that accesses a database and a map server. The map server provides general directions, maps, and geocode information. The database provides supplementary information such as a name of the building, a place to park, an elevator to take, a certain floor to meet on, and a particular person to meet. Each destination point includes customized supplementary information that provides specific directions relating to the destination point. The supplementary information can be unique to each particular business. The database can be updated by the user independent of updates to the map server. Combining the map server with the database allows a user to obtain specific door to door directions.

### BACKGROUND OF THE INVENTION

The present invention relates generally to generating directions over a network, in particular the Internet, and more particularly to generating supplementary information.

The Internet is a global network that allows users to communicate information. To access this information, a user executes a client program, usually a Web browser such as Netscape Navigator or Microsoft Explorer, on a computer system or terminal, which connects the user to the Internet. The Web browser issues specific commands to the Internet which accesses a particular server. A server is a computer system that provides information to the client through the Internet link.

By connecting to the Internet, the user can access a multitude of Web sites. A Web site is a series of screen displays (Web pages) having text, pictorial, and other information about a particular subject, organization, or company. A particular Web site can be retrieved from the Internet by specifying its Web site address to the Web browser.

The Internet is rapidly becoming a resource people turn to for a number of services. In particular, a number of business directory services have been established on the Internet, replacing the traditional business directories distributed by telephone companies. Such business directories allow a user to look up a particular business using the Internet. The business directories may contain the particular business' address and phone number.

In addition, other sites on the Internet provide map services for a variety of purposes. Some sites can simply store a large number of maps which the user can view. Other sites for a particular business or operation will often include a map showing their location. Some of these may provide general directions to the location of the business in response to a user input.

In addition to the Internet, maps are now being provided in some automobiles, using, for example, global positioning satellites to determine an automobile's location. A user can input a query and receive general directions from the user's location to a destination to which the user wants to drive. Further, an automobile computer can store the general directions in an on-board computer and notify the driver which direction to travel and which streets to turn on.

In some situations, a user may desire supplementary information relating to the destination point. For example, a user may need additional directions such as a name of the building, a place to park, an elevator to take, a certain floor to meet on, and a particular person to meet. Typically, this information may be obtained by making several phone calls.

### SUMMARY OF THE INVENTION

The present invention provides a network accessible service that accesses a database and a map server to retrieve specific door to door directions. The map server provides general directions, maps, and geocode information.

The database provides supplementary information such as a name of a building, a place to park, an elevator to take, a certain floor to meet on, and a particular person to meet. Each destination point includes customized supplementary information relating to the destination point. The supplementary information can be unique to each particular business. The database can be updated by the user independent of updates to the map server. The combination of the map server and the database allows a user to obtain specific door to door directions.

A user may input starting point and destination point data into a digital hand-held system or a computer system using a keyboard, mouse, remote control, or other input device. This data can also be retrieved from the database. Typically, the database is a relational database such as Microsoft SQL Server. The general directions are displayed from the starting point to the destination point. Typically, the general directions are displayed in the form of one or more maneuvers. The supplementary information appears to be appended to the last maneuver and is also displayed. The general directions and supplementary information can also be audibly played to the user.

One advantage of the present invention is to provide supplementary information so that an individual does not have to waste time calling and searching for important information relating to the destination point.

For a further understanding of the nature and advantages of the invention, reference should be made to the following description taken in conjunction with the accompanying drawings.

### BRIEF DESCRIPTION OF THE DRAWINGS

FIG. 1 illustrates an example of a computer system used to execute the software of the present invention;

FIG. 2 illustrates a simplified system block diagram of a typical computer system used to execute the software of an embodiment of the present invention;

FIG. 3 illustrates one example of multiple hardware systems networked over the Internet which are used to execute the software of an embodiment of the present invention;

FIG. 4 illustrates a high level flowchart of a method of providing door to doorstep directions to a user; and

FIG. 5 illustrates a display screen showing general directions and supplementary information.

### DETAILED DESCRIPTION OF SPECIFIC EMBODIMENTS

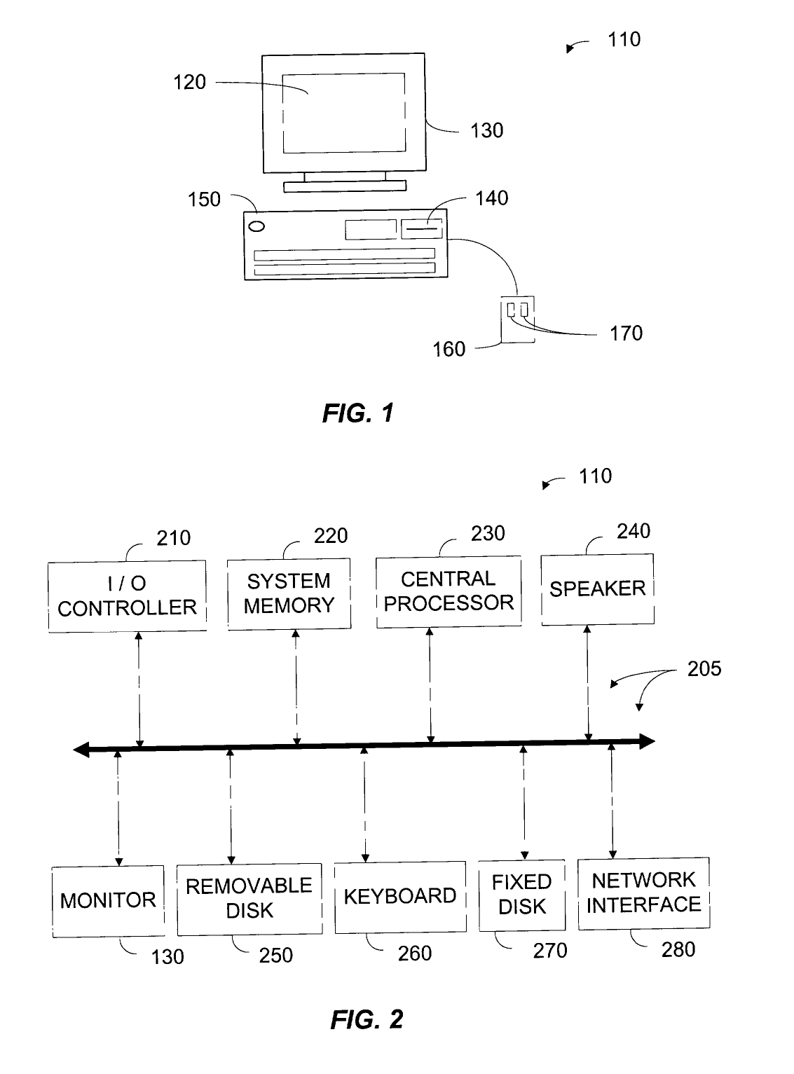

FIG. 1 illustrates an example of a computer system used to execute the software of the present invention. FIG. 1 shows a user computer system 110 which includes a monitor 130, screen 120, cabinet 150, keyboard 260 (see FIG. 2), and mouse 160. Mouse 160 may have one or more buttons such as mouse buttons 170. Cabinet 150 houses a CD-ROM drive 140 or a hard drive (not shown) which may be utilized to store and retrieve software programs incorporating the present invention, and the like. Although CD-ROM 140 is shown as the removable media, other removable tangible media including floppy disks, tape, and flash memory may be utilized. Cabinet 150 also houses familiar computer components (not shown) such as a processor, memory, and the like.

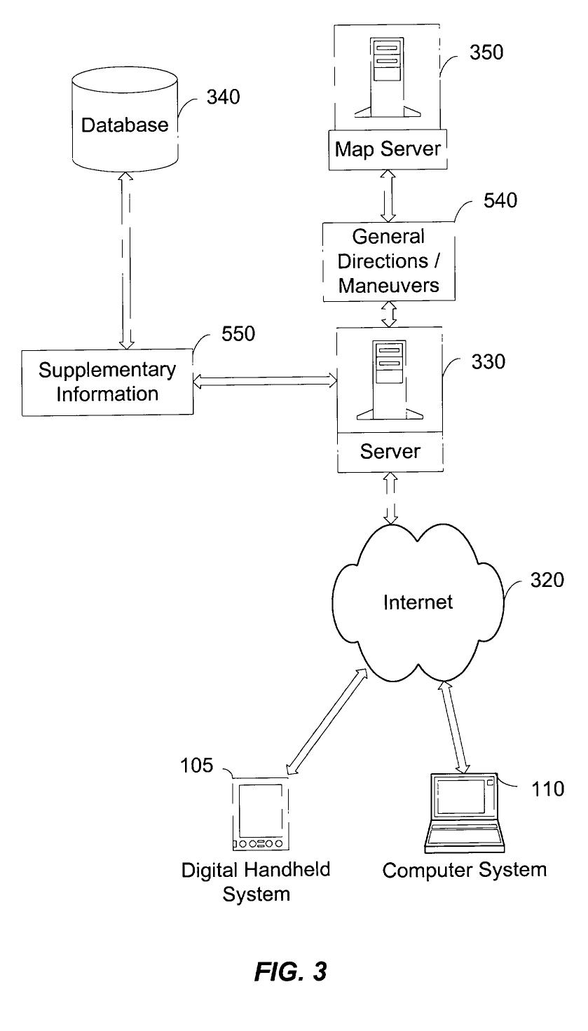

FIG. 2 illustrates a simplified system block diagram of a typical computer system 110 used to execute the software of an embodiment of the present invention. As shown in FIG. 1, computer system 110 includes monitor 130. Computer system 110 further includes subsystems such as I/O controller 210, system memory 220, central processor 230, speaker 240, removable disk 250, keyboard 260, fixed disk 270, and network interface 280. Other computer systems suitable for use with the present invention may include additional or fewer subsystems. For example, another computer system could include more than one processor 230 (i.e., a multi-processor system) or a cache memory. Also, a digital hand-held system 105 can be used to execute the software of an embodiment of the present invention (see FIG. 3).

Arrows such as 205 represent the system bus architecture of computer system 110. However, these arrows 205 are illustrative of any interconnection scheme serving to link the subsystems. For example, a local bus could be utilized to connect the central processor 230 to the system memory 220. Computer system 110 shown in FIG. 2 is but an example of a computer system suitable for use with the present invention. Other configurations of subsystems suitable for use with the present invention will be readily apparent to one of ordinary skill in the art.

FIG. 3 illustrates one example of multiple hardware systems networked over the Internet to execute the software of an embodiment of the present invention. Typically, a user accesses a network such as the Internet 320 using a digital hand-held system 105 or a computer system 110. The hand-held system 105 includes a memory for storing the software and a processor connected to the memory for executing the software of an embodiment of the present invention. Typically, the hand-held system 105 is a PalmPilot designed and manufactured by 3Com Corporation of Santa Clara, Calif. The hand-held system 105 transfers data to the server 330 using a network protocol such as TCP/IP over a wireless modem or any other network device.

The user can turn on a computer system 110, like the one shown in FIG. 1, to access a Web browser. A Web browser allows the user to gain access to the Internet 320 to retrieve information from multiple servers, such as server 330.

In one embodiment, a user may obtain general directions 540 from a starting point to a destination point. The user may also obtain supplementary information 550. The supplementary information 550 includes direction and non-direction information. For example, direction information can include a place to park and a specific elevator to use. Non-direction information can include, for example, a company logo and parking rates.

A user may input a starting and destination point into a Web page, such as the “zip2.com” Web page, via a Web browser. Also, the user may input a starting and destination point into the hand-held system 105. The starting point data may include the name or address of the starting location. The destination point data may include the name or address of the ending location. Alternatively, the starting and destination point can be selected from a list retrieved from a database 340. Database 340 includes location based information such as direction and non-direction information and business related information. The business related information includes a list of businesses, each having a unique business ID. Typically, database 340 is a relational database such as Microsoft SQL Server.

The starting and destination point data is then sent to the server 330 via the Internet 320 or a network. If the starting or destination point data is an address, the server 330 accesses a map server 350 to obtain a geocode of the address. A geocode is the latitude and longitude coordinates associated with the starting and destination point. If the starting or destination point is selected from the list of businesses, the server 330 sends the business ID to the database 340 to obtain a business record corresponding to the unique business ID. The business record includes information relating to the business such as billing, contact, geocode, and supplementary information. The business record information can be input and edited by a person having an administrative privilege. The business record information can also be input and edited independent of access to the map server 350. Typically, the person having the administrative privilege utilizes a password to access the database 340 using the Web browser.

The supplementary information 550 can include direction information such as the name of the building, a place to park, a specific meeting point and time, a specific landmark to locate, an entrance location, a specific elevator to use, a certain floor to meet on, and a particular person to meet. The supplementary information 550 provides customized directions to a particular location. The supplementary information 550 is created by entering information into a business record corresponding to a particular business that is part of the database 340. The supplementary information 550 is retrieved from the database 340 and can be altered and updated independent of the map server's 350 general directions 540. The supplementary information 550 can also include destination point information not related to the directions, e.g., non-direction information. For example, the destination point information can include a company logo, a particular office phone number, hourly parking rates, hours of operation, handicap accessibility, location of an ATM machine, location of a gas station, location of a golf course or any other information not directly related to the directions.

The business record is sent to the server 330. Server 330 searches the business record for a geocode flag and the supplementary information 550. If a computer system or operator entered the latitude and longitude coordinates into the business record, the geocode flag is set. If the geocode is set, the business has been “manually” geocoded. If the geocode flag is not set or is clear, the business has not been “manually” geocoded. In this situation, the server 330 sends the address or name of the business to the map server 350 for geocoding.

After the geocode data, i.e., latitude and longitude coordinates, of the starting and destination point has been obtained, the geocode data is sent to the map server 350 to determine a route from the starting point to the destination point. The route is usually determined by calculating the shortest time or distance from the starting point to the destination point. Generally, routing function software accessible by the map server 350 is used to generate the route.

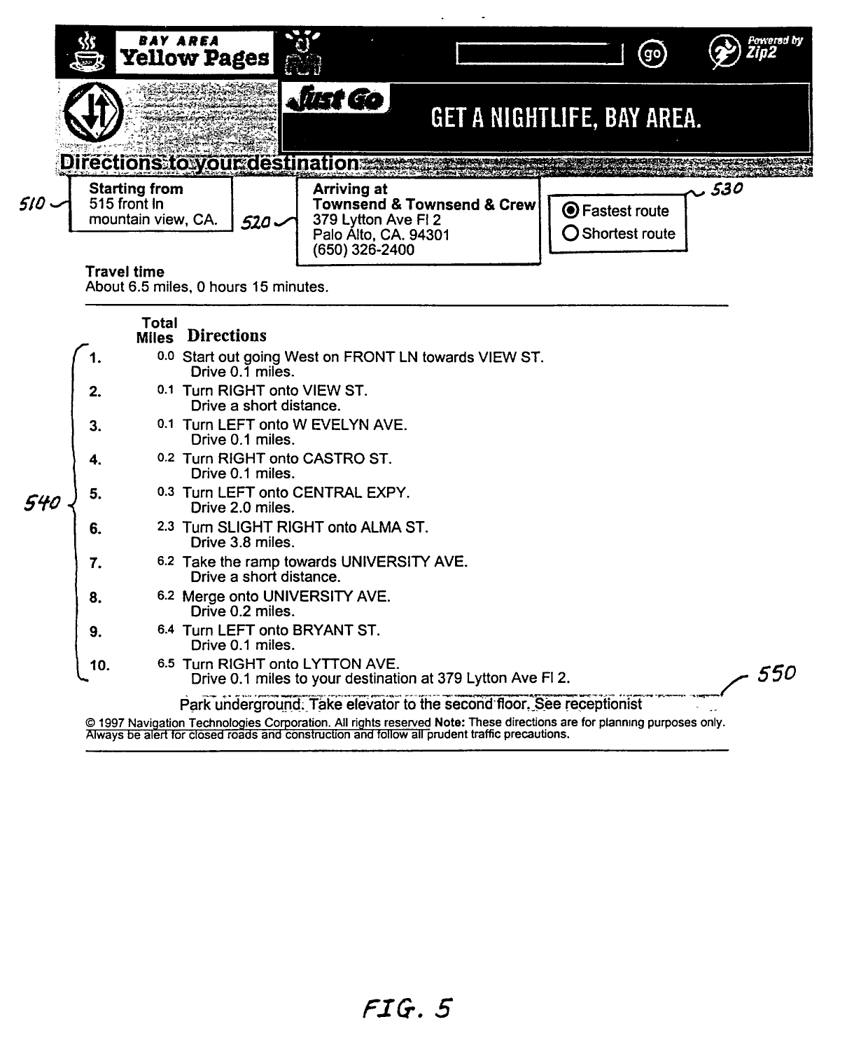

Each step or segment of the route is called a “maneuver” (see, FIG. 5). For example, “Start out going West on FRONT LN towards VIEW ST.” is one maneuver. “Turn RIGHT onto VIEW ST.” is another maneuver. Map server 350 sends the route information, i.e., maneuvers 540 or general directions, to the server 330.

The supplementary information 550 can include the following: “Free parking underground. Take the express elevator to the fifteenth floor lobby. Ask for Jane Doe, Recruiting Coordinator.” Another example of the supplementary information is “Entrance is located on Mercy Street, across from Kinko's Copy Center. Maximum time limit for street parking is 2 hours. Hours of operation are from 8:00 am to 6:00 pm, Monday thru Friday.” Typically, the supplementary information 550 is sent to the server 330 from the database 340.

Server 330 includes multiple templates which are used to generate pages of text, i.e., Web pages. The maneuvers are included on the template pages. Each template page includes multiple keys which can be either set or clear. Each key is initially in the clear state. Typically, one key corresponds to the one or more maneuvers and another key corresponds to the supplementary information. Server 330 searches the information received from the map server 350 and the database 340 to determine if one or more maneuvers and the supplementary information is present. If a maneuver is present, the server 330 sets or populates the key corresponding to the maneuver. If the supplementary information is present, the server 330 sets or populates the key corresponding to the supplementary information. The template pages are then sent to the Web browser which displays the Web pages. If a key is set, the Web browser displays the information corresponding to the set key. For example, if the maneuver key is set, the maneuvers are displayed and if the supplementary information key is set, the supplementary information is displayed. The supplementary information is typically displayed below the general directions which gives it the appearance of being appended to the last maneuver. Combining general directions from a map server 350 and supplementary information from a database 340 provide a user with specific door to door directions.

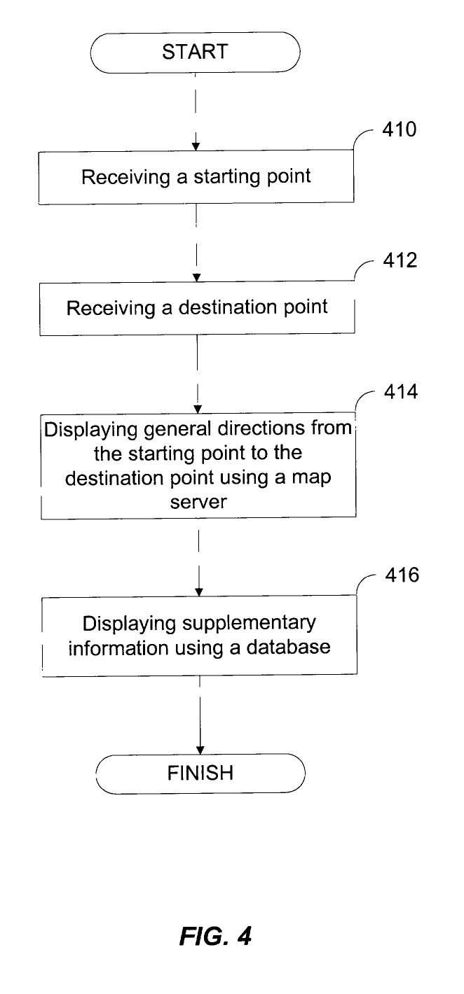

FIG. 4 illustrates a high level flowchart of a method of providing directions to a user. At step 410, a computer system or a hand-held system receives a starting point. Typically, a user is prompted to input the starting point. The starting point can be input using a keyboard, mouse, remote control, or other input device. The computer system or hand-held system can also receive the starting point data from a database or a system memory. At step 412, a user selects a destination point from a list displayed on the system screen. Typically, the user selects an address or name of the business. A keyboard, mouse, remote control, or other input device is used to select the address or name. The list of addresses or names can be retrieved from a database or computer system memory. Alternatively, the user can be prompted to input the destination point using a keyboard, mouse, remote control, or other input device. At step 414, the Web browser provides the user with general directions from the starting point to the destination point using a map server. Typically, the general directions are provided to the user by visually displaying the directions on a system screen. For example, suppose a person desires to travel from 515 Front Lane, Mountain View, Calif. to 379 Lytton Avenue, Palo Alto, Calif., the following directions will be displayed (see also FIG. 5): “Start out going West on FRONT LN towards VIEW ST. Turn RIGHT onto VIEW ST. Turn LEFT onto W. EVELYN AVE. Turn RIGHT onto CASTRO ST. Turn LEFT onto CENTRAL EXPY. Turn SLIGHT RIGHT onto ALMA ST. Take the ramp towards UNIVERSITY AVE. Merge onto UNIVERSITY AVE. Turn LEFT onto BRYANT ST. Turn RIGHT onto LYTTON AVE.” Alternatively, the directions can be provided to the user by audibly playing the direction to the user via a speaker. At step 416, the Web browser provides the user with supplementary information by accessing a database. The supplementary information is visually displayed on a computer screen. For example, the following supplementary information can be displayed: “Zip2 Corporation develops software for the World Wide Web. The main entrance is located on Mercy Street. The parking garage is located across the street from Bank of America on Castro Street. Hours of operation are from 8:30 am to 5:30 pm, Monday thru Friday.” Alternatively, the supplementary information can be provided to the user by audibly playing the supplementary information to the user via a speaker.

The destination point described above can be an intermediate destination point. For example, a user can obtain directions from a starting point to a destination point with one or more stopping points. Each stopping point represents an intermediate destination point where the user can obtain supplementary information. Each stopping points also represents an intermediate starting point for the next stopping point or the final destination point. In addition, the general directions and supplementary information can be converted by a voice synthesizer into an audio signal. The audio signal can be played through a speaker which can be included in a computer system, a car audio system, or a handheld system. Hence, the user can listen to the general directions and supplementary information while driving an automobile or being occupied with another task.

FIG. 5 illustrates a display screen showing general directions and supplementary information. The display screen shows starting point 510 and destination point 520. The route display 530 shows the fastest route, i.e., the shortest time, and the shortest route, i.e., the shortest distance, from the starting point to the destination point. As described above, the ten maneuvers 540 are displayed from numbers 1-10. Each maneuver describes a portion of the route from the starting point to the destination point. The supplementary information 550 is typically displayed below the last maneuver and appears to be appended to the last maneuver (e.g., number 10). The supplementary information 550 is highlighted to draw the user's attention to the information relating to the destination point 520.

The invention has now been explained with reference to specific embodiments. Other embodiments will be apparent to one of ordinary skill in the art. For example, the present invention can be implemented using hardware circuitry or software or a combination of hardware circuitry and software. It is therefore not intended that this invention be limited, except as indicated by the appended claims.

What is claimed is:

1. A method of providing directions to a user comprising:
receiving a starting point;
receiving a destination point;
providing general directions from the starting point to the destination point using a map server;
providing supplementary information using a database; and
displaying the general directions and supplementary information.

2. The method of claim 1 wherein the supplementary information is selected from a group consisting of a building name, a place to park, a meeting point and time, a landmark, an entrance location, an elevator to take, a certain floor to meet on, and a person to meet.

3. The method of claim 1 wherein the supplementary information is selected from a group consisting of a company logo, a particular office phone number, hourly parking rates, hours of operation, handicap accessibility, a location of an ATM machine, a location of a gas station, and a location of a golf course.

4. The method of claim 1 wherein the supplementary information is created by inputting information into the database.

5. The method of claim 1 wherein the supplementary information is altered by a user having an administrative privilege.

6. The method of claim 1 wherein the supplementary information is altered independent of alterations to the general directions.

7. The method of claim 1 wherein the step of selecting a destination point comprises selecting a business from a list of businesses obtained from the database, each business having a business ID.

8. The method of claim 7 further comprising transmitting the business ID to the database to obtain a business record corresponding to the business ID.

9. The method of claim 8 wherein providing supplementary information comprises searching the business record for the supplementary information.

10. The method of claim 1 wherein appending the supplementary information comprises attaching the supplementary information to a maneuver.

11. The method of claim 1 wherein the step of providing the general directions comprises providing at least one maneuver.

12. A method of providing directions to a user over a network comprising:
establishing a connection from a Web browser to a server through the Internet;
accessing a Web site from the Web browser;
transmitting data in the form of a Web page from the server to the Web browser;
inputting a starting point on the Web page with a user input device;
accessing a list of businesses from a database;
selecting a business having a business ID from the list of businesses using the user input device;
transmitting the starting point from the Web browser to the server;
searching the database for a business record corresponding to the business ID;
transmitting the business record to the server;
searching the business record for a geocode and supplementary information;
transmitting the geocode to a map server to determine a route from the starting point to the destination point;
displaying the route; and
displaying the supplementary information.

13. A computer system for providing directions to a user over a computer network, comprising:
a processor; and
a memory connected to the processor, the memory including code for:
receiving a starting point from a user;
receiving a destination point from the user;
providing general directions from the starting point to the destination point using a map server;
providing supplementary information using a database; and
sending the general directions and the supplementary information to the computer network for displaying the general directions and supplementary information.

14. The system of claim 13 wherein the computer system is configured to alter the supplementary information by a user having an administrative privilege.

15. The system of claim 13 wherein the computer system is configured to alter the supplementary information independent of alterations to the general directions.

16. The method of claim 13 wherein the computer system is configured to select a business having a business ID.

17. The system of claim 15 wherein the computer system is configured to transmit the business ID to the database to obtain a business record corresponding to the business ID.

18. A computer program product comprising:
a computer usable medium having computer readable code embodied therein for displaying supplementary information, the computer program product comprising:
computer readable program code configured to cause a computer to receive a starting point;
computer readable program code configured to cause a computer to receive a destination point;
computer readable program code configured to cause a computer to provide general directions from the starting point to the destination point using a map server;
computer readable program code configured to cause a computer to provide supplementary information using a database;
computer readable program code configured to cause a computer to append the supplementary information to the general directions; and
computer readable program code configured to cause a computer to display the general directions.

19. The computer program product of claim 18 wherein the supplementary information is selected from a group consisting of a building name, a place to park, an elevator to take, a certain floor to meet on, and a particular person to meet.

20. A computer program product that provides directions to a user comprising:
code that receives starting point information;
code that receives a destination point;
code that provides directions from the starting point to the destination point using a map server;
code that provides supplementary information using a database;
code that displays the general directions and supplementary information; and
a computer readable medium that stores the computer codes.

21. The computer program product of claim 20 further comprising code that allows a user to alter the database independent of alterations to the map server.
